(19) United States
(12) Patent Application Publication
(10) Pub. No.: US 2003/0209834 A1
(43) Pub. Date: Nov. 13, 2003

(54) Solvent cast films and process made thereby

(76) Inventors: Grant Hay, Evansville, IN (US); Gary Charles Davis, Albany, NY (US); Kathryn Lynn Longley, Saratoga Springs, NY (US); Zhaohui Su, Evansville, IN (US); James Alan Mahood, Evansville, IN (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 10/136,632

(22) Filed: May 2, 2002

(51) Int. Cl. C08G 64/00; C08J 5/00

(52) U.S. Cl. 264/331.11

(57) ABSTRACT

A process for the making a film comprising dissolving a polycarbonate resin in an organic solvent to form a dissolved resin wherein the polycarbonate resin comprises a polycarbonate that exhibits favorable haze; casting a film of the mixture; and removing the solvent is provided in the present invention. The aforementioned polycarbonate film is also provided in the present invention.

### BACKGROUND OF THE INVENTION

The present invention is related to isotropic films. More particularly, the present invention is related to isotropic polycarbonate films.

Polycarbonates are well-known thermoplastic materials, which due to their many advantageous properties find use as thermoplastic engineering materials. The polycarbonates exhibit, for example, excellent properties of toughness, flexibility, impact resistance, and relatively high heat distortion temperatures.

However, some thin polycarbonate resin films, particularly those prepared by the solvent casting process, exhibit somewhat less than ideal optical properties. More particularly, solvent cast films comprised of conventional polycarbonate resins exhibit a degree of haze which renders them useless for certain application where optical clarity is critical.

New materials are constantly beings sought that provide improved optical properties.

### BRIEF SUMMARY OF THE INVENTION

The present invention provides a process for the making a film comprising

(A) dissolving a polycarbonate resin in an organic solvent to form a dissolved resin wherein the polycarbonate resin comprises at least one structural unit of (I) or (II):

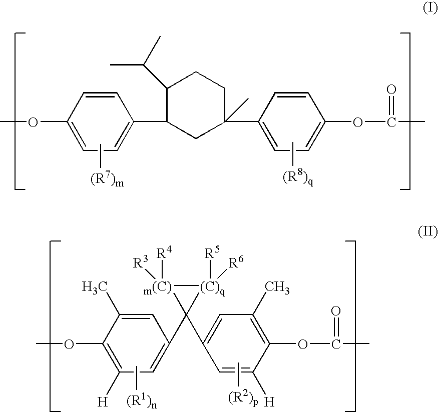

where the three optically active sites of (I) can be R isomers, S isomers, or combinations thereof;

R¹, R², R³, R⁴, R⁵, R⁶, R⁷, and R⁸ are independently selected from the group consisting of C₁-C₆ alkyl and hydrogen;

m is an integer in a range between about 1 and about 4;

q is an integer in a range between about 1 and about 4;

n is an integer in a range between about 1 and about 2; and

p is an integer in a range between about 1 and about 2;

(B) casting a film of the mixture; and

(C) removing the solvent.

The present invention further provides a film comprising a polycarbonate resin wherein the polycarbonate comprises at least one structural unit (I) or (II).

### BRIEF DESCRIPTION OF THE DRAWINGS

FIG. 1 is a graphical depiction of the viscosity versus mass fraction polymer of BHPM polycarbonate in a solvent mixture compared to BPA polycarbonate in a solvent mixture.

### DETAILED DESCRIPTION OF THE INVENTION

In this specification and in the claims that follow, reference will be made to a number of terms that shall be defined to have the following meaning.

The singular forms “a”, “an” and “the” include plural referents unless the context clearly dictates otherwise.

“Optional” or “optionally” mean that the subsequently described event or circumstance may or may not occur, and that the description includes instances where said event or circumstance occurs and instances where it does not.

Unless otherwise stated, “mol %” in reference to the composition of a polycarbonate in this specification is based upon 100 mol % of the repeating units of the polycarbonate.

In the present invention, it was unexpectedly found that an isotropic, optical film comprising polycarbonates disclosed herein exhibits favorable haze and uniform thickness which make them ideal for any relevant optical application. “Favorable haze” as used herein refers to an average haze percent less than about 4%. “Uniform thickness” as used herein refers to a thickness that does not vary by more than ±3%.

In one embodiment of the present invention, the film of the present invention comprises polycarbonate or copolycarbonate comprising at least one structural unit of (I) or (II):

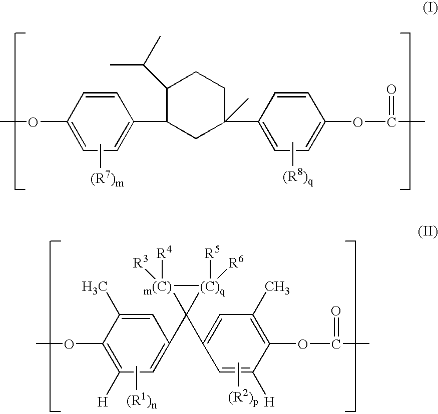

where the three optically active sites of (I) can be R isomers, S isomers, or nations thereof;

R¹, R², R³, R⁴, R⁵, R⁶, R⁷, and R⁸ are independently selected from the group consisting of C₁-C₆ alkyl and hydrogen;

m is an integer in a range between about 1 and about 4;

q is an integer in a range between about 1 and about 4;

n is an integer in a range between about 1 and about 2; and

p is an integer in a range between about 1 and about 2.

Representative units of structure (I) include residues of 1,3-bis(4-hydroxyphenyl)menthane (BHPM). Typically, the molecular weight of the polycarbonate comprising structural units of (I) is in a range between about 20,000 and about 100,000.

Representative units of structure (II) include, but are not limited, to residues of 1,1-bis(4-hydroxy-3-methylphenyl)cyclohexane (DMBPC); 1,1-bis(4-hydroxy-3-methylphenyl)cyclopentane; 1,1-bis(4-hydroxy-3-methylphenyl)cycloheptane; 1,1-bis(4-hydroxy-3-methylphenyl)-3,3,5-trimethylcyclohexane (DMBPI); and mixtures thereof. For the solution casting process it is beneficial to have a solution viscosity in a range between about 10,000 and about 300,000 centipoise (cP). For a given solids loading, a greater molecular weight will result in a higher viscosity. Thus, the molecular weight of the polycarbonate comprising structural units (II) is typically in a range between about 20,000 and about 100,000.

In an alternative embodiment of the present invention, the film comprising the polycarbonate or copolycarbonate which comprises structural units (II), further comprises carbonate structural units (III):

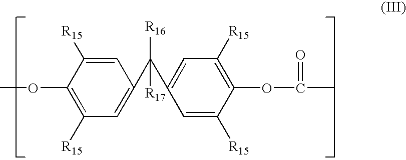

where each R₁₅ is selected independently from the group consisting of H and C₁-C₃ alkyl, and R₁₆ and R₁₇ are independently C₁-C₆ alkyl or aryl.

Representative units of structure (III) include, but are not limited to, residues of 2,2-bis(4-hydroxyphenyl)propane (BPA); 2,2-bis(4-hydroxyphenyl)butane; 2,2-bis(4-hydroxyphenyl)pentane; 2,2-bis(4-hydroxy-3-methylphenyl)propane; 2,2-bis(3-ethyl-4-hydroxyphenyl)propane; and mixtures thereof. BPA is preferred. The copolycarbonate of this embodiment typically comprises structural units (III) in a range between about 10 mole % and about 90 mole % and more typically, in a range between about 20 mole % and about 50 mole %.

In yet a further embodiment of the present invention, the polycarbonate comprising structural units of (II) and (III) may also include the reaction products of difunctional carboxylic acids of the general formula R¹⁸(COOH)₂ wherein R¹⁸ is an aryl group or alkyl group wherein the alkyl group is an alkylene or alkylidene group derived from straight-chained or branched alkyl groups. Straight-chain and branched alkyl groups are preferably those containing from about 2 to about 20 carbon atoms, and include as illustrative non-limiting examples ethyl, propyl, isopropyl, butyl, tertiary-butyl, pentyl, neopentyl, hexyl, octyl, decyl, and dodecyl. Aryl groups include, for example, phenyl and tolyl. Examples of difunctional carboxylic acids include, but are not limited to, aliphatic diacids, aromatic diacids, or combinations thereof. Examples of aliphatic diacids include adipic acid, sebacic acid, dodecanedioic acid (DDDA), C₁₉ diacid, C₃₆ dimer diacid; examples of aromatic diacids include isophthalic acid, terephthalic acid and 2,6-napthalenedicarboxylic acid. When the polycarbonate includes the reaction products of difunctional carboxylic acids, the reaction products of the difunctional carboxylic acids are typically present in a range between about 0.5 mole % and about 20 mole %.

Polymer substrates of the present invention typically have sufficient optical clarity, e.g., a birefringence of about ±100 nm or less. However, the polymer should be capable of withstanding subsequent processing parameters (e.g., application of subsequent layers) such as sputtering temperatures of about room temperature (about 25° C.) up to about 150° C., and subsequent storage conditions (e.g., in a hot car having temperatures up to about 70° C.). That is, it is desirable for the plastic to have sufficient thermal stability to prevent deformation during the various layer deposition steps as well as during storage by the end-user. Thus, materials having glass transition temperatures greater than about 200° C. should be employed. The polymer substrate of formula (I) has a glass transition temperature of greater than about 235° C.

In accordance with the process of the present invention, the polycarbonate employed for solution casting an optical film is first dissolved in an organic solvent. Any inert organic solvent may be used. An inert organic solvent is any that does not enter into reaction with the mixture components or adversely affects them. Examples of inert organic solvents include, but are not limited to methylene chloride, 1,2-dichloroethane, chlorobenzene, toluene, and combinations thereof. Typically, the solvent is methylene chloride. Before evaporation, the solvent typically contains total polycarbonate in a range between about 15 weight % and about 50 weight %, based on the total weight of the polycarbonate-solvent mixture. The viscosity of the polycarbonate-solvent mixtures is typically at least about 10,000 centipoise. After evaporation, the residual solvent level is typically less than about 0.5 weight %, and more typically, less than about 0.01 weight %, based on the total weight of the polycarbonate-solvent mixture.

Typically, the polymer is mixed into a solvent to form a solution. The polymer solution is typically filtered and a film of the solvent mixture is cast. Industrially, the solvent mixture is delivered to a coat hanger die that will uniformly spread the solution onto a highly polished metal belt. Typically, various drying conditions and methods are optimized to deliver film with a low residual solvent level. This incorporates initial drying on the belt and further drying subsequent to stripping the film from the belt. These films generally have a thickness in a range between about 0.5 mils and about 25 mils, preferably in a range between about 1 mils and about 15 mils.

In order that those skilled in the art will be better able to practice the invention, the following examples are given by way of illustration and not by way of limitation.

### EXAMPLES

### Example 1

Preparation of DMBPC Homopolycarbonate

Into a 30 liters (L) reactor was placed DMBPC (1776 grams, 6.0 mol), 10.5 L methylene chloride and 5.4 L of water. The pH was adjusted to 12.5 with 50 wt % sodium hydroxide (NaOH). Phosgene was added at 20 grams per minute (g/min), at 588 g (6.0 mol), p-cumylphenol (19.1 g, 1.5 mol %) was added and phosgene was continued until 706 g (20 mol % excess) were added. The pH was lowered to 10.5 (with phosgene) at which point 14 milliliters (mL) of triethylamine (TEA) was added over 9 minutes. The chloroformates lasted about 8 minutes from the start of the TEA addition. An additional 318 g more phosgene was added at pH 10.5. The polymer solution diluted with 12 L of methylene chloride was separated from the brine, washed with aqueous hydrochloric acid (HCl), washed with water and isolated by precipitation into methanol. Mw=109,000 (Polystyrene standards).

### Example 2

Preparation of DMBPC/BPA (50/50) Copolycarbonate

Into a 30 L reactor was placed DMBPC (888 g, 3 mol), BPA (684 g, 3 mol), p-cumylphenol (19.1 g, 1.5 mol %), 17 mL of TEA, 10.5 L methylene chloride and 5.4 L of water. The pH was adjusted to 10.5 with 50 wt % NaOH. Phosgene was added at 20 g/min until 772 g (30 mol % excess) were added. The polymer solution, diluted with 12 L of methylene chloride, was separated from the brine, washed with aqueous HCl, washed with water and isolated by precipitation into methanol. Mw=103,100 (Polystyrene standards).

### Example 3

Preparation of DMBPC/BPA/DDDA (49149/2) Terpolyestercarbonate

A 30 L phosgenator was charged with DMBPC (870 g, 2.94 mol), BPA (672 g, 2.94 mol), DDDA (27.6 g, 0.12 mol), p-cumylphenol (19.1 g, 1.5 mol %), methylene chloride (10.5 L), distilled water (5.4 L), triethylamine (25 mL) and methyltributylammonium chloride (48 mL of a 75 wt % aqueous solution). Sodium hydroxide (15 g of a 50 wt % aqueous solution) was added and the reaction mixed for 5 minutes. Phosgene (416 g, 70 mol % equivalence) was added at 20 g/min maintaining the pH at 8.5 by the addition of the NaOH solution. The pH was ramped to 10.5 over 1.5 minutes and phosgene continued until 833 g (8.4 mol, 40 mol % excess) had been added. The polymer solution was diluted with methylene chloride (12 L), separated from the brine, washed with 1N HCl followed by distilled water. The polymer was isolated by precipitation into methanol and dried overnight at 120° C. under nitrogen. Mw=101,700 (Polystyrene standards).

### Example 4

Preparation of BHPM Homopolycarbonate

1,3-Bis(4-hydroxyphenyl)menthane (5000 g, 15.4 mol) was charged to a 100L agitated reactor along with methylene chloride (23L), water (16L), triethylamine (32 ml) and p-cumylphenol (139 g). Phosgene (2180 g, 22.0 mol) was added at 130 g/min rate while the pH was held at 10.0-10.50 by controlled addition of a 50% caustic solution. The resulting polymer solution was separated from the brine layer, washed with dilute HCl solution, and then washed with water until the level of titratable chloride was less than 3 ppm. The polymer was precipitated with steam and dried. The resulting resin had Mw=24585 and Mn=9622 by GPC against PC standards.

Solvent Casting

Approximately 2 grams of polymer described in Examples 1, 2, and 3 were dissolved in 30 milliliters of methylene chloride and then filtered through a 0.45 micron syringe filter into a 14.3 centimeter open glass ring sitting on a glass plate. The surface of the glass ring in contact with the plate was ground glass to prevent leakage of the polymer solution. A nitrogen atmosphere was maintained over the polymer solution to prevent moisture condensation in the methylene chloride solution during drying. After approximately 4 to 6 hours enough methylene chloride had evaporated the glass ring was removed and the film separated from the glass plate. The remaining methylene chloride could be removed by placing the film in a heated vacuum oven for several hours. The temperature of the vacuum oven was in a range between about 40° C. and the glass transition temperature minus 20° C. (depending on the material). The temperature was increased to help remove the final solvent. The drying time was selected based on the time needed to have less than 1000 ppm solvent. The thickness of the film was 70 to 100 microns and could be adjusted by modifying the amount of polymer in solution.

Polycarbonate (PC) films were prepared using the above-described method using various materials. Subsequently, the haze of the film was measured utilizing a Geartner haze meter. Results of haze measurements can be seen in Table 1.

TABLE 1

| Material | Average Haze % | Haze Standard Deviation (%) |
|---|---|---|
| DMBPC | 1.11 | 0.89 |
| DMBPC/BPA/DDDA | 2.35 | 0.45 |
| DMBPC/BPA | 1.14 | 0.26 |
| BHPM | 1.06 | 0.33 |
| BPA | 73.9 | 0.93 |

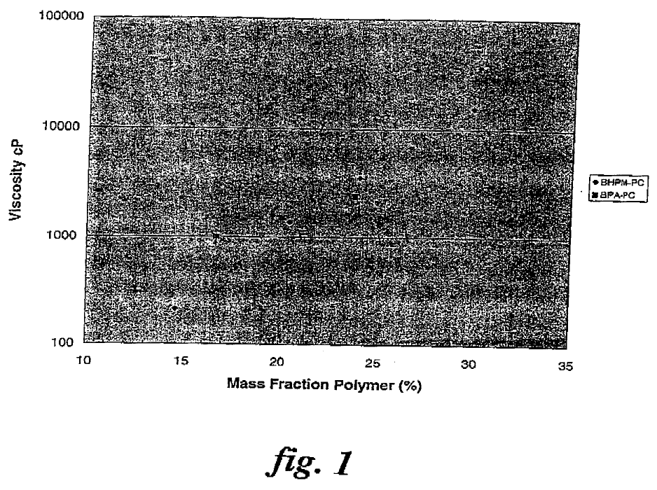

The BHPM polycarbonate has additional advantages over BPA polycarbonate. The solids loading, before phase separation occurs that could be achieved in methylene chloride as compared to BPA polycarbonate was significantly higher. This lead to a higher viscosity solution before phase separation caused inhomogenous solution properties. FIG. 1 outlines the viscosity of BHPM polycarbonate as compared to BPA polycarbonate. The viscosity was measured utilized a couetted geometry and a Parr Physica constant stress rheometer. The viscosity was measured as a function of steady shear rate and the solution viscosity was determined to be Newtonian at the concentrations of interest. The BPA polycarbonate solution had a visible hazy appearance at mass fractions of about 24% whereas the BHPM polycarbonate solutions were stable for all mass fractions outlined in the figure.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

1. A process for the making a film comprising
(A) dissolving a polycarbonate resin in an organic solvent to form a dissolved resin wherein the polycarbonate resin comprises at least one structural unit of (I) or (II): 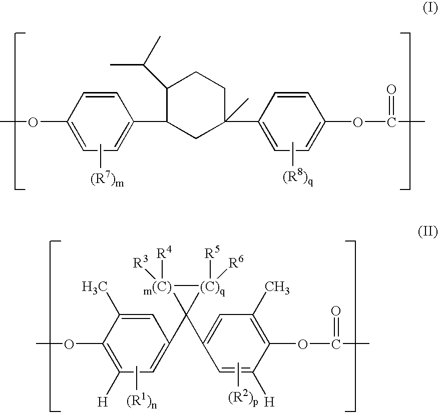
where the three optically active sites of (I) can be R isomers, S isomers, or combinations thereof;
R¹, R², R³, R⁴, R⁵, R⁶, R⁷, and R⁸ are independently selected from the group consisting of C₁-C₆ alkyl and hydrogen;
m is an integer in a range between about 1 and about 4;
q is an integer in a range between about 1 and about 4;
n is an integer in a range between about 1 and about 2; and
p is an integer in a range between about 1 and about 2;
(B) casting a film of the mixture; and
(C) removing the solvent.

2. The process in accordance with claim 1, wherein the polycarbonate resin comprises structural units of (I).

3. The process in accordance with claim 1, wherein the polycarbonate resin comprises structural units of (II).

4. The process in accordance with claim 3, wherein the structural units of (II) is 1,1-bis(4-hydroxy-3-methyl phenyl) cyclohexane.

5. The process in accordance with claim 3, wherein the polycarbonate resin further comprises structure units of (III): 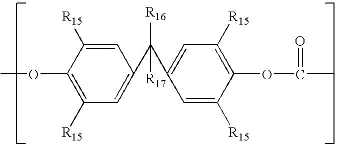
where each R₁₅ is selected independently from the group consisting of H and C₁-C₃ alkyl, and R₁₆ and R₁₇ are independently C₁-C₆ alkyl or aryl.

6. The process in accordance with claim 5, wherein the structural units of (III) is 2,2-bis(4-hydroxyphenyl)propane.

7. The process in accordance with claim 5, wherein the polycarbonate resin further comprises the reaction product of difunctional carboxylic acids.

8. The process in accordance with claim 1, wherein the organic solvent comprises methylene chloride, 1,2-dichloroethane, chlorobenzene, toluene, or combinations thereof.

9. The process in accordance with claim 8, wherein the organic solvent comprises methylene chloride.

10. The process in accordance with claim 1, wherein solvent is evaporated at room temperature.

11. The process in accordance with claim 1, wherein the viscosity of the dissolved polycarbonate resin is at least 10,000 centipoise before solvent evaporation.

12. The process in accordance with claim 1, wherein the film has a haze of less than about 4%.

13. The process in accordance with claim 1, wherein the film has a thickness in a range between about 0.5 mils and about 25 mils.

14. The process in accordance with claim 13, wherein the film has a thickness in a range between about 1 mil and about 15 mils.

15. The process in accordance with claim 1, wherein the film is isotropic.

16. A process for the making a film comprising
(A) dissolving a polycarbonate resin in methylene chloride to form a dissolved resin wherein the polycarbonate resin comprises at least one structural unit of (I): 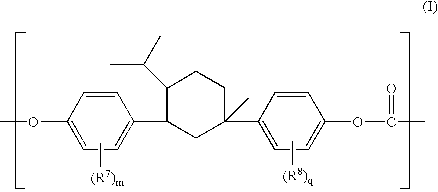
where the three optically active sites of (I) can be R isomers, S isomers, or combinations thereof;
R⁷ and R⁸ are hydrogen;
m is 4; and
q is 4;
(B) casting a film of the mixture; and
(C) removing the methylene chloride.

17. A film comprising a polycarbonate resin wherein the polycarbonate comprises at least one structural unit (I) or (II): 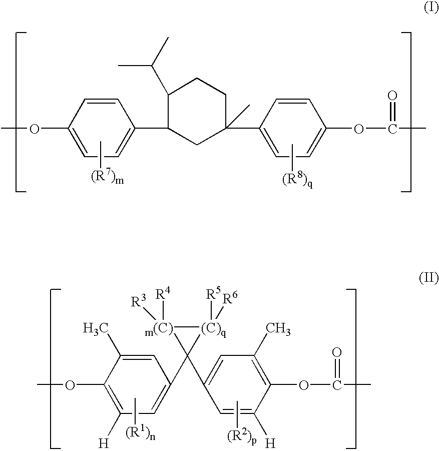
where the three optically active sites of (I) can be R isomers, S isomers, or combinations thereof;
R¹, R², R³, R⁴, R⁵, R⁶, R⁷, and R⁸ are independently selected from the group consisting of C₁-C₆ alkyl and hydrogen;
m is an integer in a range between about 1 and about 4;
q is an integer in a range between about 1 and about 4;
n is an integer in a range between about 1 and about 2; and
p is an integer in a range between about 1 and about 2.

18. The film in accordance with claim 17, wherein the polycarbonate resin comprises structural units of (I).

19. The film in accordance with claim 17, wherein the polycarbonate resin comprises structural units of (II).

20. The film in accordance with claim 19, wherein the structural units of (II) is 1,1-bis(4-hydroxy-3-methyl phenyl) cyclohexane.

21. The film in accordance with claim 19, wherein the polycarbonate resin further comprises structure units of (III): 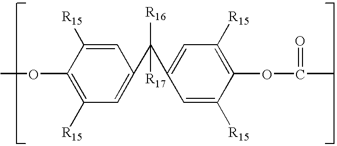
where each R₁₅ is selected independently from the group consisting of H and C₁-C₃ alkyl, and R₁₆ and R₁₇ are independently C₁-C₆ alkyl or aryl.

22. The film in accordance with claim 21, wherein the structural units of (III) is 2,2-bis(4-hydroxyphenyl)propane.

23. The film in accordance with claim 21, wherein the polycarbonate resin further comprises the reaction product of difunctional carboxylic acids.

24. The film in accordance with claim 17, wherein the film has a haze of less than about 4%.

25. The film in accordance with claim 17, wherein the film has a thickness in a range between about 0.5 mils and about 25 mils.

26. The film in accordance with claim 25, wherein the film has a thickness in a range between about 1 mil and about 15 mils.

27. The film in accordance with claim 17, wherein the film is isotropic.

28. A isotropic film comprising a polycarbonate resin wherein the polycarbonate comprises structural unit (I): 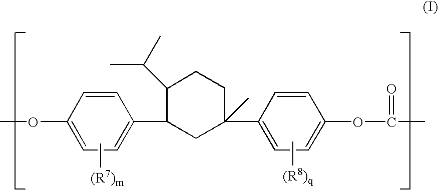
where the three optically active sites of (I) can be R isomers, S isomers, or combinations thereof;
R⁷ and R⁸ are hydrogen;
m is 4; and
q is 4.
